(19) United States
(12) Patent Application Publication
(10) Pub. No.: US 2006/0259344 A1
(43) Pub. Date: Nov. 16, 2006

(54) Statistical personalized recommendation system

(75) Inventors: Jayendu Patel, Somerville, MA (US); Michael Strickman, Weston, MA (US)

Correspondence Address: FISH & RICHARDSON PC, P.O. BOX 1022, MINNEAPOLIS, MN, 55440-1022, US

(73) Assignee: Choicestream, a Delaware corporation

(21) Appl. No.: 11/488,416

(22) Filed: Jul. 18, 2006

Related U.S. Application Data
(62) Division of application No. 10/643,439, filed on Aug. 19, 2003.
(60) Provisional application No. 60/404,419, filed on Aug. 19, 2002.
(60) Provisional application No. 60/422,704, filed on Oct. 31, 2002.
(60) Provisional application No. 60/448,596, filed on Feb. 19, 2003.

(51) Int. Cl. G06F 9/46

(52) U.S. Cl. 705/9

(57) ABSTRACT

A method for recommending items in a domain to users, either individually or in groups, makes user of users' characteristics, their carefully elicited preferences, and a history of their ratings of the items are maintained in a database. Users are assigned to cohorts that are constructed such that significant between-cohort differences emerge in the distribution of preferences. Cohort-specific parameters and their precisions are computed using the database, which enable calculation of a risk-adjusted rating for any of the items by a typical non-specific user belonging to the cohort. Personalized modifications of the cohort parameters for individual users are computed using the individual-specific history of ratings and stated preferences. These personalized parameters enable calculation of a individual-specific risk-adjusted rating of any of the items relevant to the user. The method is also applicable to recommending items suitable to groups of joint users such a group of friends or a family. A related method can be used to discover users who share similar preferences. Similar users to a given user are identified based on the closeness of the statistically computed personal-preference parameters.

### CROSS-REFERENCE TO RELATED APPLICATIONS

This application is a divisional of and claims the benefit of U.S. application Ser. No. 10/643,439, filed Aug. 19, 2003, which claims the benefit of U.S. Provisional Application No. 60/404,419, filed Aug. 19, 2002, U.S. Provisional Application No. 60/422,704, filed Oct. 31, 2002, and U.S. Provisional Application No. 60/448,596 filed Feb. 19, 2003. These applications are incorporated herein by reference.

### BACKGROUND

This invention relates to an approach for providing personalized item recommendations to users using statistically based methods.

### SUMMARY

In a general aspect, the invention features a method for recommending items in a domain to users, either individually or in groups. Users' characteristics, their carefully elicited preferences, and a history of their ratings of the items are maintained in a database. Users are assigned to cohorts that are constructed such that significant between-cohort differences emerge in the distribution of preferences. Cohort-specific parameters and their precisions are computed using the database, which enable calculation of a risk-adjusted rating for any of the items by a typical non-specific user belonging to the cohort. Personalized modifications of the cohort parameters for individual users are computed using the individual-specific history of ratings and stated preferences. These personalized parameters enable calculation of a individual-specific risk-adjusted rating of any of the items relevant to the user. The method is also applicable to recommending items suitable to groups of joint users such a group of friends or a family. In another general aspect, the invention features a method for discovering users who share similar preferences. Similar users to a given user are identified based on the closeness of the statistically computed personal-preference parameters.

In one aspect, in general, the invention features a method, software, and a system for recommending items to users in one or more groups of users. User-related data is maintained, including storing a history of ratings of items by users in the one or more groups of users. Parameters associated with the one or more groups using the user-related data are computed. This computation includes, for each of the one or more groups of users, computation of parameters characterizing predicted ratings of items by users in the group. Personalized statistical parameters are computed for each of one or more individual users using the parameters associated with that user's group of users and the stored history of ratings of items by that user. Parameters characterizing predicted ratings of the items by the each of one or more users are then enabled to be calculated using the personalized statistical parameters.

In another aspect, in general, the invention features a method, software, and a system for identifying similar users. A history of ratings of the items by users in a group of users is maintained. Parameters are then calculated using the history of ratings. These parameters are associated with the group of users and enable computation of a predicted rating of any of the items by an unspecified user in the group. Personalized statistical parameters for each of one or more individual users in the group are also calcualted using the parameters associated with the group and the history of ratings of the items by that user. There personalized parameters enable computation of a predicted rating of any of the items by that user. Similar users to a first user are identified using the computed personalized statistical parameters for the users.

Other features and advantages of the invention are apparent from the following description, and from the claims.

### DESCRIPTION OF DRAWINGS

FIG. 1 is a data flow diagram of a recommendation system;

FIG. 2 is a diagram of data representing the state of knowledge of items, cohorts, and individual users;

FIG. 3 is a diagram of a scorer module;

FIG. 4 is a diagram that illustrates a parameter-updating process;

### DESCRIPTION

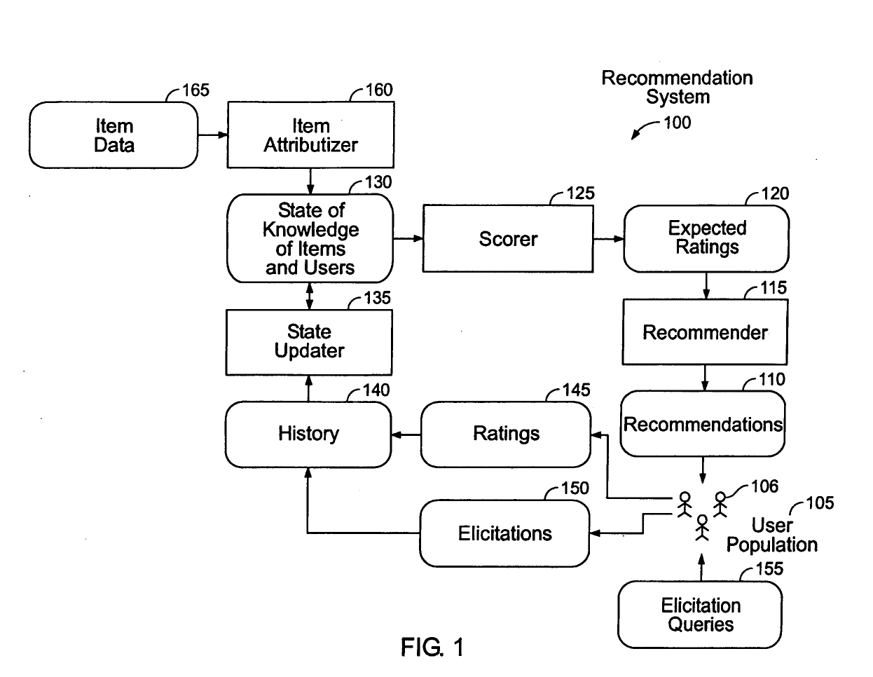

1 Overview (FIG. 1)

Referring to FIG. 1, a recommendation system 100 provides recommendations 110 of items to users 106 in a user population 105. The system is applicable to various domains of items. In the discussion below movies are used as an example domain. The approach also applies, for example, to music albums/CDs, movies and TV shows on broadcast or subscriber networks, games, books, news, apparel, recreational travel, and restaurants. In the first version of the system described below, all items belong to only one domain. Extensions to recommendation across multiple domains are feasible.

The system maintains a state of knowledge 130 for items that can be recommended and for users for whom recommendations can be made. A scorer 125 uses this knowledge to generate expected ratings 120 for particular items and particular users. Based on the expected ratings, a recommender 115 produces recommendations 110 for particular users 106, generally attempting to recommend items that the user would value highly.

To generate a recommendation 110 of items for a user 106, recommendation system 100 draws upon that user's history of use of the system, and the history of use of the system by other users. Over time the system receives ratings 145 for items that users are familiar with. For example, a user can provide a rating for a movie that he or she has seen, possibly after that movie was previously recommended to that user by the system. The recommendation system also supports an elicitation mode in which ratings for items are elicited from a user, for example, by presenting a short list of items in an initial enrollment phase for the user and asking the user to rate those items with which he or she is familiar or allowing the user to supply a list of favorites.

Additional information about a user is also typically elicited. For example, the user's demographics and the user's explicit likes and dislikes on selected item attributes are elicited. These elicitation questions are selected to maximize the expected value of the information about the user's preferences taking into account the effort required to elicit the answers from the user. For example, a user may find that it takes more “effort” to answer a question that asks how much he or she likes something as compared to a question that asks how often that user does a specific activity. The elicitation mode yields elicitations 150. Ratings 145 and elicitations 150 for all users of the system are included in an overall history 140 of the system. A state updater 135 updates the state of knowledge 130 using this history. This updating procedure makes use of statistical techniques, including statistical regression and Bayesian parameter estimation techniques.

Recommendation system 100 makes use of explicit and implicit (latent) attributes of the recommendable items. Item data 165 includes explicit information about these recommendable items. For example, for movies, such explicit information includes the director, actors, year of release, etc. An item attributizer 160 uses item data 165 to set parameters of the state of knowledge 130 associated with the items. Item attributizer 160 estimates latent attributes of the items that are not explicit in item data 165.

Users are indexed by n which ranges from 1 to N. Each user belongs to one of a disjoint set of D cohorts, indexed by d. The system can be configured for various definitions of cohorts. For example, cohorts can be based on demographics of the users such as age or sex and on explicitly announced tastes on key broad characteristics of the items. Alternatively, latent cohort classes can be statistically determined based on a weighted composite of demographics and explicitly announced tastes. The number and specifications of cohorts are chosen according to statistical criteria, such as to balance adequacy of observations per cohort, homogeneity within cohort, or heterogeneity between cohorts. For simplicity of exposition below, the cohort index d is suppressed in some equations and each user is assumed assigned on only one cohort. The set of users belonging to cohort d is denoted by D_{d}. The system can be configured to not use separate cohorts in recommending items by essentially considering only a single cohort with D=1.

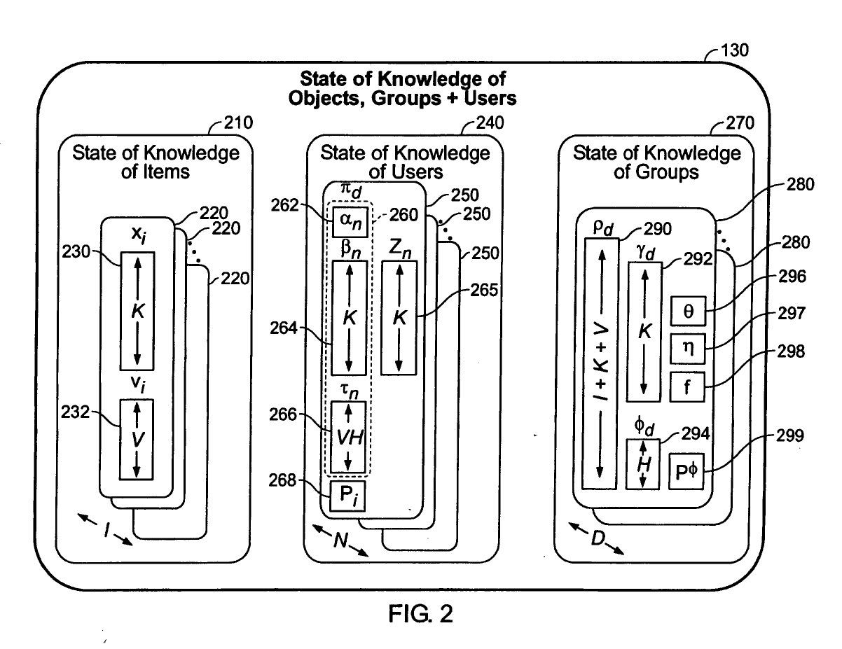

2 State of Knowledge 130 (FIG. 2)

Referring to FIG. 2, state of knowledge 130 includes state of knowledge of items 210, state of knowledge of users 240, and state of knowledge of cohorts 270.

State of knowledge of items 210 includes separate item data 220 for each of the I recommendable items.

Data 220 for each item i includes K attributes, xᵢₖ, which are represented as a K-dimensional vector, xᵢ 230. Each xᵢₖ is a numeric quantity, such as a binary number indicating presence or absence of a particular attribute, a scalar quantity that indicates the degree to which a particular attribute is present, or a scalar quantity that indicates the intensity of the attribute.

Data 220 for each item i also includes V explicit features, vᵢₖ, which are represented as a V-dimensional vector, vᵢ 232. As is discussed further below, some attributes xᵢₖ are deterministic functions of these explicit features and are termed explicit attributes, while other of the attributes xᵢₖ are estimated by item attributizer 160 based on explicit features of that item or of other items, and based on expert knowledge of the domain.

For movies, examples of explicit features and attributes are the year of original release, its MPAA rating and the reasons for the rating, the primary language of the dialog, keywords in a description or summary of the plot, production/distribution studio, and classification into genres such as a romantic comedy or action sci-fi. Examples of latent attributes are a degree of humor, of thoughtfulness, and of violence, which are estimated from the explicit features.

State of knowledge of users 240 includes separate user data 250 for each of the N users.

Data for each user n includes an explicit user “preference” zₙₖ for one or more attributes k. The set of preferences is represented as a K-dimensional vector, zₙ 265. Preference zₙₖ indicates the liking of attribute k by user n relative to the typical person in the user's cohort. Attributes for which the user has not expressed a preference are represented by a zero value of zₙₖ. A positive (larger) value zₙₖ corresponds to higher preference (liking) relative to the cohort, and a negative (smaller) zₙₖ corresponds to a preference against (dislike) for the attribute relative to the cohort.

Data 250 for each user n also includes statistically estimated parameters πₙ 260. These parameters include a scalar quantity αₙ 262 and a K-dimensional vector βₙ 264 that represent the estimated (expected) “taste” of the user relative to the cohort which is not accounted for by their explicit preference. Parameters αₙ 262 and βₙ 264, together with the user's explicit “preference” zₙ 265, are used by scorer 125 in mapping an item's attributes xᵢ 230 to an expected rating of that item by that user. Statistical parameters 265 for a user also include a V+1 dimensional vector τₙ 266 that are used by scorer 125 in weighting a combination of an expected rating for the item for the cohort to which the user belongs as well as explicit features vᵢ 232 to the expected rating of that item by that user. Statistical parameters πₙ 260 are represented as the stacked vector πₙ=[αₙ,β′ₙ, τ′ₙ]′ of the components described above.

User data 250 also includes parameters characterizing the accuracy or uncertainty of the estimated parameters πₙ in the form of a precision (inverse covariance) matrix Pₙ 268. This precision matrix is used by state updater 135 in updating estimated parameters 260, and optionally by scorer 125 in evaluating an accuracy or uncertainty of the expected ratings it generates.

State of knowledge of cohorts 270 includes separate cohort data 280 for each of the D cohorts. This data includes a number of statistically estimated parameters that are associated with the cohort as a whole. A vector of regression coefficients p_{d} 290, which is of dimension 1+K+V, is used by scorer 125 to map a stacked vector (1, x′ᵢ, v′ᵢ)′ for an item i to a rating score for that item that is appropriate for the cohort as a whole.

The cohort data also includes a K-dimensional vector γ_{d} 292 that is used to weight the explicit preferences of members of that cohort. That is, if a user n has expressed an explicit preference for attribute k of zₙₖ, and user n is in cohort d, then that product \tilde{z}ₙₖ=zₙₖ γ_{dk} is used by scorer 125 in determining the contribution based on the user's explicit ratings as compared to the contribution based on other estimated parameters, and in determining the relative contribution of explicit preferences for different of the K attributes. Other parameters, including θ_{d} 296, η_{d} 297, and φ_{d} 294, are estimated by state updater 135 and used by scorer 125 in computing a contribution of a user's cohort to the estimated rating. Cohort data 280 also includes a cohort rating or fixed-effect vector f 298, whose elements are the expected rating f_{id} of each item i based on the sample histories of the cohort d that “best” represent a typical user of the cohort. Finally, cohort data 280 includes a prior precision matrix P_{d} 299, which characterizes a prior distribution for the estimated user parameters πᵢ 280, which are used by state updater 125 as a starting point of a procedure to personalize parameters to an individual user.

A discussion of how the various variables in state of knowledge 130 are determined is deferred to Section 4 in which details of state updater 125 are presented.

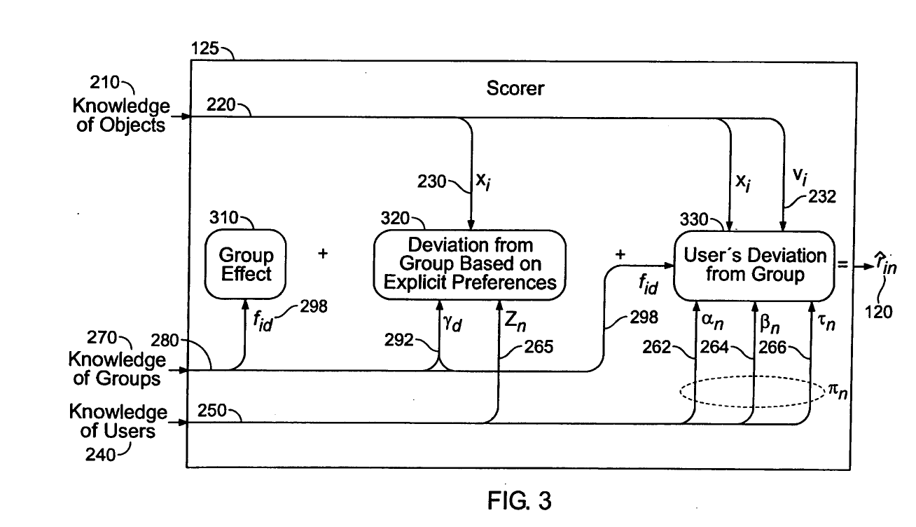

3 Scoring (FIG. 3)

Recommendation system 100 employs a model that associates a numeric variable rᵢₙ to represent the cardinal preference of user n for item i. Here rᵢₙ can be interpreted as the rating the user has already given, or the unknown rating the user would give the item. In a specific version of the system that was implemented for validating experiments, these rating lie on a 1 to 5 scale. For eliciting ratings from the user, the system maps descriptive phrases, such as “great” or “OK” or “poor,” to appropriate integers in the valid scale.

For an item i that a user n has not yet rated, recommendation system 100 treats the unknown rating rᵢₙ that user n would give item i as a random variable. The decision on whether to recommend item i to user n at time t is based on state of knowledge 130 at that time. Scorer 125 computes an expected rating \hat{r}ᵢₙ 120, based on the estimated statistical properties of rᵢₙ, and also computes a confidence or accuracy of that estimate.

The scorer 125 computes \hat{r}ᵢₙ based on a number of sub-estimates that include:
a. A cohort-based prior rating f_{id} 310, which is an element of f 298.
b. An explicit deviation 320 of user i's rating relative to the representative or prototypical user of the cohort d to which the user belongs that is associated with explicitly elicited deviations in preferences for the attributes xᵢ 230 for the item. These deviations are represented in the vector zₙ 265. An estimated mapping vector γ_{d} 292 for the cohort translates the deviations in preferences into rating units.
c. An inferred deviation 330 of user i's rating (relative to the representative or prototypical user of the cohort d to which the user belongs taking into account the elicited deviations in preferences) arises from any non-zero personal parameters, αₙ 262, βₙ 264, and τₙ 266, in the state of knowledge of users 130. Such non-zero estimates of the personal parameters are inferred from the history of ratings of the user i. This inferred ratings deviation is the inner product of the personal parameters with the attributes xᵢ 230, the cohort effect term f_{id} 298, and features vᵢ 232.

The specific computation performed by scorer 125 is expressed as:

$$\begin{matrix}{\hat{r}}_{in} = ( {f}_{id} ) + ( {\tilde{z}}_{n} {x}_{i} ) + ( {α}_{n} + {β}_{n} {x}_{i} + {{τ}_{n} [ {f}_{id} , {v}_{i}^{′} ]}^{′} ) \\ = ( {f}_{id} ) + ( {\tilde{z}}_{n} {x}_{i} ) + ( {{π}_{n} [ 1 , {x}_{i}^{′} , {f}_{id} , {v}_{i}^{′} ]}^{′} )\end{matrix} \qquad ( 1 )$$

Here the three parenthetical terms correspond to the three components (a.-c.) above, and \tilde{z}ₙ≡diag(zₙ)γ_{d} (i.e., the direct product of zₙ and γ_{d}). Note that multiplication of vectors denotes inner products of the vectors.

As discussed further below, f_{id} is computed as a combination of a number of cohort-based estimates as follows:
f_{id}=α_{d}+θ_{id}\overline{r}_{i,d}+η_{id}\overline{r}_{i,\d}+(1−θ_{id}−η_{id})p_{d}[1,x′_{i,}v′_{i]′} (2)

where

$${\overline{r}}_{i , d} = {\sum }_{m ∈ {D}_{d}} {r}_{im} / {N}_{i , d}$$

is the average rating for item i for users of the cohort, and \overline{r}_{i,\d} is the average rating for users outside the cohort. As discussed further below, parameters θ_{id} and η_{id} depend on an underlying set of estimated parameters φ_{d}=(Φ₁, . . . , Φ₄) 294.

Along with the expected rating for an item, scorer 125 also provides an estimate of the accuracy of the expected rating, based on an estimate of the variance using the rating model. In particular, an expected rating \hat{r}ᵢₙ is associated with a variance of the estimate σᵢₙ² which is computed using the posterior precision of the user's parameter estimates.

Scorer 125 does not necessarily score all items in the domain. Based on preferences elicited from a user, the item set is filtered based on the attributes for the item by the scorer before passing computing the expected ratings for the items and passing them to the recommender.

4 Parameter Computation

Cohort data 280 for each cohort d includes a cohort effect term f_{id} for each item i. If there are sufficient ratings of item i by users belonging to D_{d}, whose number is denoted by N_{i,d}, then the cohort effect term f_{id} can be efficiently estimated by the sample's average rating,

$${\overline{r}}_{i , d} = {\sum }_{m ∈ {D}_{d}} {r}_{im} / {N}_{i , d} .$$

In many instances, N_{i,d} is insufficient and the value of the cohort effect term of the rating is only imprecisely estimated by the sample average of the ratings by other users in the cohort. A better finite-sample estimate of f_{id} is obtained by combining the estimate due to \overline{r}_{i,d} with alternative estimators, which may not be as asymptotically efficient or perhaps not even converge.

One alternative estimator employs ratings of item i by users outside of cohort d. Let N_{i,\d} denote the number of such ratings available for item i. Suppose the cohorts are exchangeable in the sense that inference is invariant to permutation of cohort suffixes. This alternative estimator, the sample average of these N_{i,\d} rating for item i users outside cohort, is denoted \overline{r}_{8,\d}.

A second alternative estimator is a regression of rᵢₘ on [1, x′ᵢ, v′ᵢ]′ yielding a vector of regression coefficients p_{d} 290. This regression estimator is important for items that have few ratings (possibly zero, such as for brand new items).

All the parameter for the estimators, as well as parameters that determine the relative weights of the estimators, are estimated together using the following non-linear regression equation based on the sample of all ratings from the users of cohort d:
rᵢₘ=α_{d}+θ_{id}\overline{r}_{i,d\m}+η_{id}\overline{r}_{i,\d}+(1−θ_{id}−η_{id})[1, x′ᵢ, v′ᵢ]p_{d}+xᵢdiag(zₘ)γ_{d}+uᵢₘ (3)

Here \overline{r}_{i,d\m} is the mean rating for item i by users in cohort d excluding user m; p_{d} is interpretable as the vector of coefficients associated with the item's attributes that can predict the average between-item variation in ratings without using information on the ratings assigned to the items by other users (or when some of the items for whom prediction is sought are as yet unrated). The weights θ_{id} and η_{id} are nonlinear functions of N_{i,d} and N_{i,\d} which depend on the underlying set of parameters φ_{d}=(Φ₁, . . . , Φ₄) 294:

$${θ}_{id} = \frac{{N}_{i , d}}{{N}_{i , d} + {ϕ}_{1} / ( 1 + {ϕ}_{2} {ⅇ}^{- {ϕ}_{3} {ln N}_{i , \backslash d}} ) + ϕ4} , \\ and$$

$${η}_{id} = \frac{{ϕ}_{1} / ( 1 + {ϕ}_{2} {ⅇ}^{- {ϕ}_{3} {ln N}_{i , \backslash d}} )}{{N}_{i , d} + {ϕ}_{1} / ( 1 + {ϕ}_{2} {ⅇ}^{- {ϕ}_{3} {ln N}_{i , \backslash d}} ) + ϕ4}$$

The Φⱼ's are positive parameters to be estimated. Note that the relative importance of \overline{r}_{i,d\m} grows with N_{i,d}.

All the parameters in equation (3) are invariant across users in the cohort d. However, with small N_{□,d}, even these parameters may not be precisely estimated. In such cases, an alternative is to impose exchangeability across cohorts for the coefficients of equation (3) and then draw strength from pooling the cohorts. Modern Bayesian estimation employing Markov-Chain Monte-Carlo methods are suitable with the practically valuable assumption of exchangeability.

The key estimates obtained from fitting the non-linear regression (3) to the sample data, whether by classical methods for each cohort separately or by pooled Bayesian estimation under assumptions of exchangeability, are: γ_{d}, and the parameters that enable f_{id} to be computed for different i.

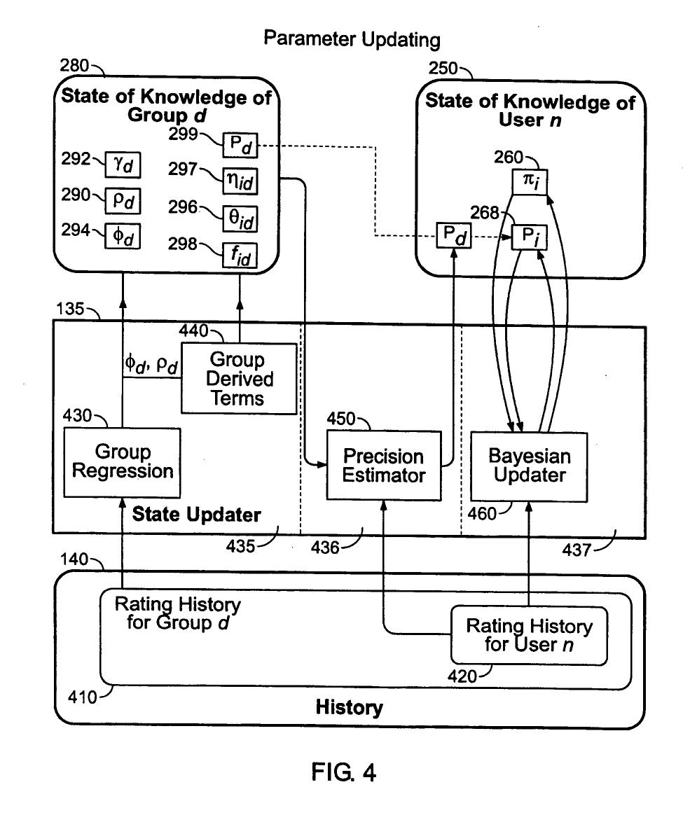

Referring to FIG. 4, state updater 135 includes a cohort regression module 430 that computes the quantities γ_{d} 292, p_{d} 290, and the four scalar components of φ_{d}=(Φ₁, Φ₂, Φ₃, Φ₄) 294 using equation (2). Based on these quantities, a cohort derived terms module 440 computes θ_{id} 296 and η_{id} 297 and from those f_{id} 298 according to equation (2).

State updater 135 also includes a Bayesian updater 460 that updates parameters of user data 280. In particular, Bayesian updater 460 maintains an estimate πₙ=(αₙ, β′ₙ, τₙ)′ 260, as well as a precision matrix Pₙ 268. The initial values of Pₙ and πₙ are common to all users of a cohort. The value of πₙ is initially zero.

The initial value of Pₙ is computed by precision estimator 450, and is a component for cohort data 280, P_{d}. The initial value of the precision matrix Pₙ is obtained through a random coefficients implementation of equation (1) without the f_{id} term. Specifically, each user in a cohort is assumed to have coefficient that are a random draw from a fixed multivariate normal distribution whose parameters are to be estimated. In practice, the multivariate normal distribution is assumed to have a diagonal covariance matrix for simplicity. The means and the variances of the distribution are estimated using Markov-Chain Monte-Carlo methods common to empirical Bayes estimation. The inverse of this estimated variance matrix is used as the initial precision matrix Pₙ.

Parameters of state of users 250 are initially set when the cohort terms are updated and then incrementally updated at intervals thereafter. In the discussion below, time index t=0 corresponds to the time of the estimation of the cohort terms, and a sequence of time indices t=1, 2, 3 . . . correspond subsequent times at which user parameters are updated.

State updater 135 has three sets of modules. A first set 435, includes cohort regression module 430 and cohort derived terms module 440. These modules are executed periodically, for example, once per week. Other regular or irregular intervals are optionally used, for example, every hour, day, monthly, etc. A second set 436 includes precision estimator 450. This module is generally executed less often that the others, for example, one a month. The third set 437 includes Bayesian updater 460. The user parameters are updated using this module as often as whenever a user rating is received, according to the number of ratings that have not been incorporated into the estimates, or periodically such as ever hour, day, week etc.

The recommendation system is based on a model that treats each unknown rating rᵢₙ (i.e., for an item i that user n has not yet rated) as an unknown random variable. In this model random variable rᵢₙ is a function of unknown parameters that are themselves treated as random variables. In this model, the user parameters πₙ=(αₙ, β′ₙ, τₙ)′ introduced above that are used to computer the expected rating \hat{r}ᵢₙ are estimates of those unknown parameters. In this model, the true (unknown random) parameter π*ₙ is distributed as a multivariate Gaussian distribution with mean (expected value) πₙ and covariance Pₙ⁻¹, which can be represented as π*ₙ □ N(πₙ, Pₙ⁻¹).

Under this model, the unknown random rating is expressed as:
rᵢₙ=(f_{id})+(\tilde{z}ₙxᵢ)+(π*ₙ[1, x′ᵢ, f_{id}, v′ᵢ]′)+εᵢₙ (4)

where εᵢₙ is an error term, which is not necessarily independent and identically distributed for different values of i and n.

For a user n who has rated item i with a rating rᵢₙ, a residual term \check{r}ᵢₙ reflects the component of the rating not accounted for by the cohort effect term, or the contribution of the user's own preferences. The residual term has the form
\check{r}ᵢₙ=rᵢₙ−(f_{id})−(\tilde{z}ₙxᵢ)=π*ₙ[1, x′ᵢ, f_{id}, v′ᵢ]′+εᵢₙ

As the system obtains more ratings by various users for various items, the estimate of the mean and the precision of that variable are updated. At time index t, using ratings up to time index t, the random parameters are distributed as π*ₙ □ N(πₙ^{(t)}, Pₙ^{(t)}). As introduced above, prior to taking into account any ratings by user n, the random parameters are distributed as π*ₙ □ N(0, P_{d}), that is, πₙ⁽⁰⁾=0 and Pₙ⁽⁰⁾=P_{d}.

At time index t+1, the system has received a number of ratings of items by users n, which we denote h, that have not yet been incorporated into the estimates of the parameters πₙ^{(t)} and Pₙ^{(t)}. An h-dimensional (column) vector \check{r}ₙ is formed from the h residual terms, and the corresponding stacked vectors (1, x′ᵢ, f_{id}, v′ᵢ)′ form a h-column by 2+K+V-row matrix A.

The updated estimate of the parameters πₙ^{(t+1)} and Pₙ^{(t+1)} given \check{r}ₙ and A and the prior parameter values πₙ^{(t)} and Pₙ^{(t)} are found by the Bayesian formulas:
πₙ^{(t+1)}=(Pₙ^{(t)}+A′A)⁻¹(Pₙ^{(t)}πₙ^{(t)}+A′\check{r}ₙ), Pₙ^{(t+1)}=Pₙ^{(t)}+A′A (5)

Equation (5) is applied at time index t=1 to incorporate all the user's history of ratings prior to that time. For example, time index t=1 is immediately after the update to the cohort parameters, and subsequent time indices correspond to later times when subsequent of the user's ratings incorporated. In an alternative approach, equation (5) is reapplied using t=1 repeatedly starting from the prior estimate and incorporating the user's complete rating history. This alternative approach provides a mechanism for removing ratings from the user's history, for example, if the user re-rates an item, or explicitly withdraws a past rating.

5 Item Attributizer

Referring to FIGS. 1-2, item attributizer 160 determines data 220 for each item i. As introduced above, data 220 for each item i includes K attributes, xᵢₖ, which are represented as K-dimensional vector, xᵢ 230, and V features, vᵢₖ, which are represented as V-dimensional vector, vᵢ 232. The specifics of the procedure used by item attributizer 160 depends, in general, on the domain of the items. The general structure of the approach is common to many domains.

Information available to item attributizer 160 for a particular item includes values of a number of numerical fields or variables, as well as a number of text fields. The output attribute xᵢₖ corresponds to features of item i for which a user may express an implicit or explicit preference. Examples of such attributes include “thoughtfulness,” “humor,” and “romance.” The output features vᵢₖ may be correlated with a user's preference for the item, but for which the user would not in general express an explicit preference. An example of such an attribute is the number or fraction of other users that have rated the item.

In a movie domain, examples of input variables associated with a movie include its year of release, its MPAA rating, the studio that released the film, and the budget of the film. Examples of text fields are plot keywords, keyword that the movie is an independent-film, text that explains the MPAA rating, and a text summary of the film. The vocabularies of the text fields are open, in the range of 5,000 words for plot keywords and 15,000 words for the summaries. As is described further below, the words in the text fields are stemmed and generally treated as unordered sets of stemmed words. (Ordered pairs/triplets of stemmed words can be treated as unique meta-words if appropriate.)

Attributes xᵢₖ are divided into two groups: explicit attributes and latent (implicit) attributes. Explicit attributes are deterministic functions of the inputs for an item. Examples of such explicit attributes include indicator variables for the various possible MPAA ratings, an age of the film, or an indicator that it is a recent release.

Latent attributes are estimated from the inputs for an item using one of a number of statistical approaches. Latent attributes form two groups, and a different statistical approach is used for attributes in each of the groups. One approach uses a direct mapping of the inputs to an estimate of the latent attribute, while the other approach makes use of a clustering or hierarchical approach to estimating the latent attributes in the group.

In the first statistical approach, a training set of items are labeled by a person familiar with the domain with a desired value of a particular latent attribute. An example of such a latent attribute is an indication of whether the film is an “independent” film. For this latent variable, although an explicit attribute could be formed based on input variables for the film (e.g., the producing/distributing studio's typical style or movie budget size), a more robust estimate is obtained by treating the attribute as latent and incorporating additional inputs. Parameters of a posterior probability distribution Pr(attr. k|input i), or equivalently the expected value of the indicator variable for the attribute, are estimated based on the training set. A logistic regression approach is used to determine this posterior probability. A robust screening process selects the input variables for the logistic regressions from the large candidate set. In the case of the “independent” latent attribute, pre-fixed inputs include the explicit text indicator that the movie is independent-film and the budget of the film. The value of the latent attribute for films outside the training set is then determined as the score computed by the logistic regression (i.e., a number between 0 and 1) given the input variables for such items.

In the second statistical approach, items are associated with clusters, and each cluster is associated with a particular vector of scores of the latent attributes. All relevant vectors of latent scores for real movies are assumed to be spanned by positively weighted combinations of the vectors associated with the clusters. This is expressed as:
E(Sᵢₖ|inputs of i)=Σ_{c}S_{ck}×Pr(i ε cluster c|inputs of i)
where S_{□k} denotes the latent score on attribute k, and E(□) denotes the mathematical expectation.

The parameters of the probability functions on the right-hand side of the equation are estimated using a training set of items. Specifically, a number of items are grouped into clusters by one or more persons with knowledge of the domain, hereafter called “editors.” In the case of movies, approximately 1800 movies are divided into 44 clusters. For each cluster, a number of prototypical items are identified by the editors who set values of the latent attributes for those prototypical items, i.e., S_{ck}. Parameters of probability, Pr(i ε cluster c|inputs of i), are estimated using a hierarchical logistic regression. The clusters are divided into a two-level hierarchy in which each cluster is uniquely assigned to a higher-level cluster by the editors. In the case of movies, the 44 clusters are divided into 6 higher-level clusters, denoted C, and the probability of membership is computed using a chain rule as
Pr(cluster c|input i)=Pr(cluster c|cluster C, input i)Pr(cluster C|input i)

The right-hand side probabilities are estimated using a multinomial logistic regression framework. The inputs to the logistic regression are based on the numerical and categorical input variables for the item, as well as a processed form of the text fields.

In order to reduce the data in the text fields, for each higher-level cluster C, each of the words in the vocabulary is categories into one of a set of discrete (generally overlapping) categories according to the utility of the word in discriminating between membership in that category versus membership in some other category (i.e., a 2-class analysis for each cluster). The words are categorized as “weak,” “medium,” or “strong.” The categorization is determined by estimating parameters of a logistic function whose inputs are counts for each of the words in the vocabulary occurring in each of the text fields for an item, and the output is the probability of belonging to the cluster. Strong words are identified by corresponding coefficients in the logistic regression having large (absolute) values, and medium and weak words are identified by corresponding coefficients having values in lower ranges. Alternatively, a jackknife procedure is used to assess the strength of the words. Judgments of the editors are also incorporated, for example, by adding or deleting works or changing the strength of particular words.

The categories for each of the clusters are combined to form a set of overlapping categories of words. The input to the multinomial logistic function is then the count of the number of words in each text field in each of the categories (for all the clusters). In the movie example with 6 higher-level categories, and three categories of word strength, this results in 18 counts being input to the multinomial logistic function. In addition to these counts, additional inputs that are based on the variables for the item are added, for example, an indicator of the genre of a film.

The same approach is repeated independently to compute Pr(cluster c|cluster C, input i) for each of the clusters C. That is, this procedure for mapping the input words to a fixed number of features is repeated for each of the specific clusters, with different with different categorization of the words for each of the higher-level clusters. With C higher-level clusters, an additional C multinomial logistic regression function are determined to compute the probabilities Pr(cluster c|cluster C, input i).

Note that although the training items are identified as belonging to a single cluster, in determining values for the latent attributes for an item, terms corresponding to each of the clusters contribute to the estimate of the latent attribute, weighted by the estimate of membership in each of the clusters.

The V explicit features, vᵢₖ, are estimated using a similar approach as used for the attributes. In the movie domain, in one version of the system, these features are limited to deterministic functions of the inputs for an item. Alternatively, procedures analogous to the estimation of latent attributes can be used to estimate additional features.

6 Recommender

Referring to FIG. 1, recommender 115 takes as inputs values of expected ratings of items by a user and creates a list of recommended items for that user. The recommender performs a number of functions that together yield the recommendation that is presented to the user.

A first function relates to the difference in ranges of ratings that different users may give. For example, one user may consistently rate items higher or lower than another. That is, their average rating, or their rating on a standard set of items may differ significantly from than for other users. A user may also use a wider or narrower range of rating than other users. That is, the variance of their ratings or the sample variance of a standard set of items may differ significantly from other users.

Before processing the expected ratings for items produced by the scorer, the recommender normalizes the expected ratings to a universal scale by applying a user-specific multiplicative and an additive scaling to the expected ratings. The parameters of these scalings are determined to match the average and standard deviation on a standard set of items to desired target values, such as an average of 3 and a standard deviation of 1. This standard set of items is chosen such that for a chosen size of the standard set (e.g., 20 items) the value of the determinant of X′X is maximized, where X is formed as a matrix whose columns are the attribute vectors xᵢ for the items i in the set. This selection of standard items provides an efficient sampling of the space of items based on differences in their attribute vectors. The coefficients for this normalization process are stored with other data for the user. The normalized expected rating, and its associated normalized variance are denoted \hat{\tilde{r}}ᵢₙ and \tilde{σ}ᵢₙ².

A second function is performed by the scorer is to limit the items to consider based on a preconfigured floor value of the normalized expected rating. For example, items with normalized expected ratings lower than 1 are discarded.

A third function performed by the recommender is to combine the normalized expected rating with its (normalized) variance as well as some editorial inputs to yield a recommendation score, sᵢₙ. Specifically, the recommendation score is computed by the recommender as:
sᵢₙ=\hat{\tilde{r}}ᵢₙ−φ_{1,n}\tilde{σ}ᵢₙ+φ_{2,n}xᵢ+φ₃E_{id}

The term φ_{1,n} represents a weighting of the risk introduced by an error in the rating estimate. For example, an item with a high expected rating but also a high variance in the estimate is penalized for the high variance based on this term. Optionally, this term is set by the user explicitly based on a desired “risk” in the recommendations, or is varied as the user interacts with the system, for instance starting at a relatively high value and being reduced over time.

The term φ_{2,n} represents a “trust” term. The inner product of this term with attributes xᵢ is used to increase the score for popular items. One use of this term is to initially increase the recommendation score for generally popular items, thereby building trust in the user. Over time, the contribution of this term is reduced.

The third term φ₃E_{id} represents an “editorial” input. Particular items can optionally have their recommendation score increased or decreased based on editorial input. For example, a new film which is expected to be popular in a cohort but for which little data is available could have the corresponding term E_{id} set to a non-zero value. The scale factor φ₃ determines the degree of contribution of the editorial inputs. Editorial inputs can also be used to promote particular items, or to promote relatively profitable items, or items for which there is a large inventory.

7 Elicitation Mode

When a new user first begins using the system, the system elicits information from the new user to begin the personalization process. The new user responds to a set of predetermined elicitation queries 155 producing elicitations 150, which are used as part of the history for the user that is used in estimating user-specific parameters for that user.

Initially, the new user is asked his or her age, sex, and optionally is asked a small number of additional questions to determine their cohort. For example, in the movie domain, an additional question related to whether the watch independent films is asked. From these initial questions, the user's cohort is chosen and fixed.

For each cohort, a small number of items are pre-selected and the new user is asked to rate any of these items with which he or she is familiar. These ratings initialize the user's history or ratings. Given the desired number of such items, with is typically set in the range of 10-20, the system pre-selects the items to maximize the determinant of the matrix X′X where the columns of X are the stacked attribute and feature vectors (x′ᵢv′ᵢ)′ for the items.

The new user is also asked a number of questions, which are used to determine the value of the user's preference vector zₙ. Each question is designed to determine a value for one (or possibly more) of the entries in the preference vector. Some preferences are used by the scorer to filter out items from the choice set, for example, if the user response “never” to a question such as “Do you ever watch horror films?” In addition to these questions, some preferences are set by rule for a cohort, for example, to avoid recommending R-rated films for a teenager who does not like science fiction, based on an observation that these tastes are correlated in teenagers.

8 Additional Terms

The approach described above, the correlation structure of the error term εᵢₙ in equation (4) is not taken into account in computing the expected rating \hat{r}ᵢₙ. One or both of two additional terms are introduced based on an imposed structure of the error term that relates to closeness of different items and closeness of different users. In particular, an approach to effectively modeling and taking into account the correlation structure of the error terms is used to improve the expected rating using was can be viewed as a combination of user-based and an item-based collaborative filtering term.

An expected rating \hat{r}ᵢₙ for item i and user n is modified based on actual ratings that have been provided by that user for other items j and actual ratings for item i by other users m in the same cohort. Specifically, the new rating is computed as
\hat{\hat{r}}ᵢₙ=\hat{r}ᵢₙ+Σⱼ\hat{λ}ᵢⱼ\hat{ε}ⱼₙ+Σₘ\hat{ω}ₘₙ\hat{ε}ᵢₘ

where \hat{ε}ᵢₙ≡\hat{r}ᵢₙ−rᵢₙ are fitted residual values based on the expected and actual ratings.

The terms Λ=[\hat{λ}ᵢⱼ] and Ω=[\hat{ω}ᵢⱼ] are structured to allow estimation of a relative small number of free parameters. This modeling approach is essentially equivalent to gathering the errors εᵢₙ in a I□N-dimensional vector ε and forming an error covariance as E (εε′)=Λ [symbol] Ω.

One approach to estimating these terms is to assume that the entries of Λ have the form \hat{λ}ᵢⱼ=\hat{λ}₀\hat{λ}ᵢⱼ where the terms \tilde{λ}ᵢⱼ are precomputed terms that are treated as constants, and the scalar term \hat{λ}₀ is estimated. Similarly, the other term assumes that the entries of Ω have the form \hat{ω}ₘₙ=\hat{ω}₀\hat{ω}ₘₙ.

One approach to precomputing the constants is as \tilde{λ}ᵢⱼ=||xᵢ−xⱼ|| where the norm is optionally computed using the absolute differences of the attributes (L1 norm), using a Euclidean norm (L2 norm), or using a covariance weighted norm using a covariance Σ_{β} is the covariance matrix of the taste parameters of the users in the cohort.

In the analogous approach, the terms \tilde{ω}ᵢⱼ represent similarity between users and is computed as ||Δₙₘ||, where Δₙₘ ≡(βₙ+zₙγ)−(βₘ+zₘγ). A covariance-weighted norm, Δ′ₙₘΣₓΔₙₘ, uses Σₓ, which is the covariance matrix of the attributes of items in the domain, and the scaling idea here is that dissimilarity is more important for those tastes associated with attributes having greater variation across items;

Another approach to computing the constant terms uses a Bayesian regression approach using E(\hat{ε}ᵢₘ|\hat{ε}ⱼₘ)=λᵢⱼ\hat{ε}ⱼₘ. The residuals are based on all users in the same cohort who rate both items i and j, λᵢⱼ˜N(λᵢⱼ⁰, σ_{λ}) and λᵢⱼ⁰ is specified based on prior information about the closeness of items of type i and j (for example, the items share a known common attribute (e.g., director of movie) that was not included in the model's xᵢ or the preference-weighted distance between their attributes is unusually high/low). The Bayesian regression for estimating the λᵢⱼ-parameters may provide the best estimate but is computationally expensive. It employs \hat{ε}'s to ensure good estimates of the parameters associated with the error-structure of equation (4). To obtain the \hat{ε}'s in practice for these regressions when no preliminary λᵢⱼ values have been computed, the approach ignores the error-correlation structure (i.e., λᵢⱼ⁰=0) and compute the individual-specific idiosyncratic coefficients of equation (4) for each individual in the sample given the cohort function. The residuals from the personalized regressions are the \hat{ε}'s. Regardless, the λᵢⱼ-parameters can always be conveniently pre-computed since they do not depend on user n for whom the recommendations are desired. That is, the computations of the λᵢⱼ-parameters are conveniently done off-line and not in real-time when specific recommendations are being sought.

Similarly, the Bayesian regression E(\hat{ε}ⱼₙ|\hat{ε}ⱼₘ)=ωₙₘ\hat{ε}ⱼₘ, where the residuals are based on equation is based on all items that have been jointly rated by users m and n. The regression method may not prove as powerful here since the number of items that are rated in common by both users may be small; moreover, since there are many users, real time computation of N regressions may be costly. To speed up the process, the users can optionally be clustered into G□ N groups or equivalently the Ω matrix can be factorized with G factors.

9 Other Recommendation Approaches

9.1 Joint Recommendation

In a first alternative recommendation approach, the system described above optionally provides recommendations for a group of users. The members of the group may come from different cohorts, may have histories of rating different items, and indeed, some of the members may not have rated any items at all.

The general approach to such joint recommendation is to combine the normalized expected ratings \hat{\tilde{r}}ᵢₙ for each item for all users n in a group G. In general, in specifying the group, different members of the group are identified by the user soliciting the recommendation as more “important” resulting in a non-uniform weighting according to coefficients ω_{nG}, where Σ_{nεG}ω_{nG}=1. If all members of the group are equally “important,” the system sets the weights equal to ω_{nG}=|G|⁻¹. The normalized expected joint rating is then computed as
\hat{\tilde{r}}_{iG}=Σ_{nεG}ω_{nG}\hat{\tilde{r}}ᵢₙ

Joint recommendation scores s_{iG} are then computed for each item for the group incorporating risk, trust, and editorial terms into weighting coefficients φ_{k,G} where the group as a whole is treated as a composite “user”:
s_{iG}=\hat{\tilde{r}}_{iG}−φ_{1,G}\tilde{σ}_{iG}+φ_{2,G}xᵢ+φ₃E_{iG}

The risk term is conveniently the standard deviation (square root of variance) \tilde{σ}_{iG}, where the variance for the normalized estimate is computed accord to the weighted sum of individual variances of the members of the group. As with individual users, the coefficients are optionally varied over time to introduce different contributions for risk and trust terms as the users' confidence in the system increases with the length of their experience of the system.

Alternatively, the weighted combination is performed after recommendation scores for individual users sᵢₙ are computed. That is,
s_{iG}=Σ_{nεG}ω_{nG}sᵢₙ

Computation of a joint recommendation on behalf of one user requires accessing information about other users in the group. The system implements a two-tiered password system in which a user's own information in protected by a private password. In order for another user to use that user's information to derive a group recommendation, the other user requires a “public” password. With the public password, the other user can incorporate the user's information into a group recommendation, but cannot view information such as the user's history of ratings, or even generate a recommendation specifically for that user.

In another alternative approach to joint recommendation, recommendations for each user are separately computed, and the recommendation for the group includes at least a best recommendation for each use in the group. Similarly, items that fall below a threshold score for any user are optionally removed from the joint recommendation list for the group. A conflict between a highest scoring item for one user in the group that scores below the threshold for some other user is resolved in one of a number of ways, for example, by retaining the item as a candidate. The remaining recommendations are then included according to their weighted ratings or scores as described above. Yet other alternatives include computing joint ratings from individual ratings using a variety of statistics, such as the maximum, the minimum, or the median individual ratings for the items.

The groups are optionally predefined in the system, for example, corresponding to a family, a couple, or some other social unit.

9.2 Affinity Groups

The system described above can be applied to identifying “similar” users in addition to (or alternatively instead of) providing recommendations of items to individuals or groups of users. The similarity between users is used to can be applied to define a user's affinity group.

One measure of similarity between individual users is based on a set of standard items, J. These items are chosen using the same approach as described above to determine standard items for normalizing expected ratings, except here the users are not necessarily taken from one cohort since an affinity group may draw users from multiple cohorts.

For each user, a vector of expected ratings for each of the standard items is formed, and the similarity between a pair of users is defined as a distance between the vector of ratings on the standard items. For instance, a Euclidean distance between the ratings vectors is used. The size of an affinity group is determined by a maximum distance between users in a group, or by a maximum size of the group.

Affinity groups are used for a variety of purposes. A first purpose relates to recommendations. A user can be provided with actual (as opposed to expected) recommendations of other members of his or her affinity group.

Another purpose is to request ratings for an affinity group of another user. For example, a user may want to see ratings of items from an affinity group of a well known user.

Another purpose is social rather than directly recommendation-related. A user may want to find other similar people, for example, to meet or communicate with. For example, in a book domain, a user may want to join a chat group of users with similar interests.

Computing an affinity group for a user in real time can be computationally expensive due to the computation of the pair wise user similarities. An alternative approach involves precomputing data that reduces the computation required to determine the affinity group for an individual user.

One approach to precomputing such data involves mapping the rating vector on the standard items for each user into a discrete space, for example, by quantizing each rating in the rating vector, for example, into one of three levels. For example, with 10 items in the standard set, and three levels of rating, the vectors can take on one of 3¹⁰ values. An extensible hash is constructed to map each observed combination of quantized ratings to a set of users. Using this precomputed hash table, in order to compute an affinity group for a user, users with similar quantized rating vectors are located by first considering users with the identical quantized ratings. If there are insufficient users with the same quantized ratings, the least “important” item in the standard set is ignored and the process repeated, until there are sufficient users in the group.

Alternative approaches to forming affinity groups involve different similarity measures based on the individuals' statistical parameters. For example, differences between users' parameter vectors π (taking into account the precision of the estimates) can be used. Also, other forms of pre-computation of groups can be used. For example, clustering techniques (e.g., agglomerative clustering) can be used to identify groups that are then accessed when the affinity group for a particular user is needed.

Alternatively, affinity groups are limited to be within a single cohort, or within a predefined number of “similar” cohorts.

9.3 Targeted Promotions

In alternative embodiments of the system, the modeling approach described above for providing recommendations to users is used for selecting targeted advertising for those users, for example in the form of personalized on-line “banner” ads or paper or electronic direct mailings.

9.4 Gift Finders

In another alternative embodiment of the system, the modeling approach described above for providing recommendations to users is used to find suitable gifts for known other users. Here the information is typically limited. For example, limited information on the targets for the gift may be demographics or selected explicit tastes such that the target may be explicitly or probabilistically classified into explicit or latent cohorts.

10 Latent Cohorts

In another alternative embodiment, users may be assigned to more than one cohort, and their membership may be weighted or fractional in each cohort. Cohorts may be based on partitioning users by directly observable characteristics, such as demographics or tastes, or using statistical techniques such as using estimated regression models employing latent classes. Latent class considerations offer two important advantages: first, latent cohorts will more fully utilize information on the user; and, second, the number of cohorts can be significantly reduced since users are profiled by multiple membership in the latent cohorts rather than a single membership assignment. Specifically, we obtain a cohort-membership model that generates user-specific probabilities for user n to belong to latent cohort d, Pr(n ε D_{d}|demographics of user n, zₙ). Here user n's explicitly elicited tastes are zₙ.

Estimates of Pr(n ε D_{d}|demographics of user n, zₙ) are obtained by employing a latent class regression that extends equation (3) above. While demanding, this computation is off-line and infrequent. With latent cohorts, the scorer 125 uses a modification of the inputs indicated in equation (1): for example, f_{id} is replaced by the weighted average

$${\sum }_{d = 1}^{D} Pr ( n ∈ d \vert demographics , {z}_{n} ) \times {f}_{id} .$$

For the scores, the increased burden with latent cohorts is very small, which allows the personalized recommendation system to remain very scalable.

11 Multiple Domain Approach

The approach described above considers a single domain of items, such as movies or books. In an alternative system, multiple domains are jointly considered by the system. In this way, a history in one domain contributes to recommendations for items in the other domain. One approach to this is to use common attribute dimensions in the explicit and latent attributes for items.

It is to be understood that the foregoing description is intended to illustrate and not to limit the scope of the invention, which is defined by the scope of the appended claims. Other embodiments are within the scope of the following claims.

What is claimed is:

1. A method for identifying similar users comprising:
maintaining a history of ratings of the items by users in a group of users;
computing parameters using the history of ratings, said parameters being associated with the group of users and enabling computation of a predicted rating of any of the items by an unspecified user in the group;
computing personalized statistical parameters for each of one or more individual users in the group using the parameters associated with the group and the history of ratings of the items by that user, said personalized parameters enabling computation of a predicted rating of any of the items by that user;
identifying similar users to a first user using the computed personalized statistical parameters for the users.

2. The method of claim 1 wherein identifying the similar users includes computing predicted ratings on a set of items for the first user and a set of potentially similar users, and selecting the similar users from the set according to the predicted ratings.

3. The method of claim 1 wherein identifying the similar users includes identifying a social group.

4. The method of claim 3 wherein the social group includes members of a computerized chat room.

5. Software stored on a computer readable media comprising instructions for causing a computer system to perform functions comprising:
maintaining a history of ratings of the items by users in a group of users;
computing parameters using the history of ratings, said parameters being associated with the group of users and enabling computations of a predicted rating of any of the items by an unspecified user in a group;
computing personalized statistical parameters for each of one or more individual users in the group using the parameters associated with the group and the history of ratings of the items by that user, said personalized parameters enabling computation of a predicted rating of any of the items of that user;
identifying similar users to a first user using the computed personalized statistical parameters for the users.
